(19) United States
(12) Patent Application Publication
(10) Pub. No.: US 2026/0219820 A1
(43) Pub. Date: Jul. 30, 2026

(54) STORAGE MEDIUM STORING APPLICATION PROGRAM, INFORMATION PROCESSING APPARATUS, AND CONTROL METHOD OF THE SAME

(71) Applicant: CANON KABUSHIKI KAISHA, Tokyo (JP)

(72) Inventor: KENTA MATSUI, Ibaraki (JP)

(21) Appl. No.: 19/444,667

(22) Filed: Jan. 9, 2026

(30) Foreign Application Priority Data
Jan. 27, 2025 (JP) 2025-011381

(51) Int. Cl. G06F 3/12

(52) U.S. Cl. CPC G06F 3/1253; G06F 3/1205

(57) ABSTRACT

A non-transitory computer-readable storage medium stores an application program which causes an information processing apparatus to perform a control method, the application program cooperating with Internet Printing Protocol (IPP) Class Driver, and the control method includes specifying predetermined attribute to request capability information indicating functions available on a printing apparatus, receiving capability information including information regarding a plurality of setting items in response to the request, and causing a display of the information processing apparatus to display the setting items.

### BACKGROUND

### Field of the Technology

The present disclosure relates to a storage medium storing an application program, an information processing apparatus, and a corresponding control method, and in particular, for communication with a printing apparatus and generation of print data.

### DESCRIPTION OF THE RELATED ART

A general-purpose printer driver (a local printer driver) that directly communicates with a printing apparatus using an industry standard protocol such as the Internet Printing Protocol (IPP) is widely used. The local printer driver is a printer driver that is provided by a provider of an operating system (OS) of a client terminal and generates print data that can be interpreted by printers of a plurality of printer vendors (printer manufacturers).

A user can transmit print data to a printing apparatus by using the local printer driver without installing a printer driver specific to a vendor on an information processing apparatus.

Further, there is printing using a cloud print service. In the cloud print service, a printer driver (a cloud printer driver) for the cloud print service is installed on an information processing apparatus.

The cloud printer driver is also a driver provided by a provider of an OS of a client terminal and is a printer driver using the IPP that generates print data that can be interpreted by printers of a plurality of printer vendors. In the cloud print service, the information processing apparatus transmits print data to the cloud print service using the cloud printer driver, and the cloud print service transmits the print data to a printing apparatus, thereby executing printing.

Regarding printing using a cloud print service, there is a technique for generating print data of application data based on Portable Document Format (PDF), Microsoft Word, or the like that is handled by an information processing apparatus and transmitting the print data to a printing apparatus.

For example, Japanese Patent Laid-Open No. 2021-33526 describes a technique for allowing the use of a print function of a printing apparatus that is not defined by the IPP. However, there are many print functions of a printing apparatus that are not defined by the IPP, and it is not efficient to deal with each function by defining an attribute for the function to use the many functions.

### SUMMARY

According to an aspect of the present disclosure, a non-transitory computer-readable storage medium stores an application program which causes an information processing apparatus to perform a control method, the application program cooperating with Internet Printing Protocol (IPP) Class Driver, and the control method includes specifying predetermined attribute information to request capability information indicating functions available on a printing apparatus, receiving capability information including information regarding a plurality of setting items in response to the request, and causing a display of the information processing apparatus to display the setting items.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating an example of a general configuration of a printing system including a client terminal as an information processing apparatus according to an embodiment of the present disclosure.

FIGS. 2A to 2D are diagrams illustrating examples of hardware configurations of modules of the printing system.

FIG. 3 is a sequence diagram illustrating processing that is executed by the modules of the printing system and starts by selecting a print queue in the client terminal.

FIG. 4 is a flowchart illustrating processing when the client terminal according to the present embodiment requests capability information.

FIG. 5 is a flowchart illustrating processing when a printer according to the present embodiment returns capability information as a response.

FIG. 6 is a flowchart illustrating processing when the client terminal according to the present embodiment transmits print data.

FIG. 7 is a flowchart illustrating processing when the printer according to the present embodiment receives print data.

FIGS. 8A and 8B are diagram illustrating tables of various print attributes held in the client terminal and the printer according to the present embodiment.

FIG. 9 is a diagram illustrating examples of print settings screens of the client terminal according to the present embodiment.

FIGS. 10A and 10B are a diagram illustrating examples of attribute values of Internet Printing Protocol (IPP) extension attributes according to the present embodiment.

FIG. 11 is a diagram illustrating examples of IPP commands used by the client terminal and the printer according to the present embodiment.

### DESCRIPTION OF THE EMBODIMENTS

Embodiments will be described in detail below with reference to the attached drawings. The following embodiments do not limit the disclosure according to the appended claims. Although a plurality of features is described in the embodiments, not all the plurality of features is essential for the disclosure, and the plurality of features may be optionally combined together. Further, in the attached drawings, the same or similar components are designated by the same reference numbers, and are not redundantly described.

Embodiments of the present disclosure will be described below with reference to the drawings.

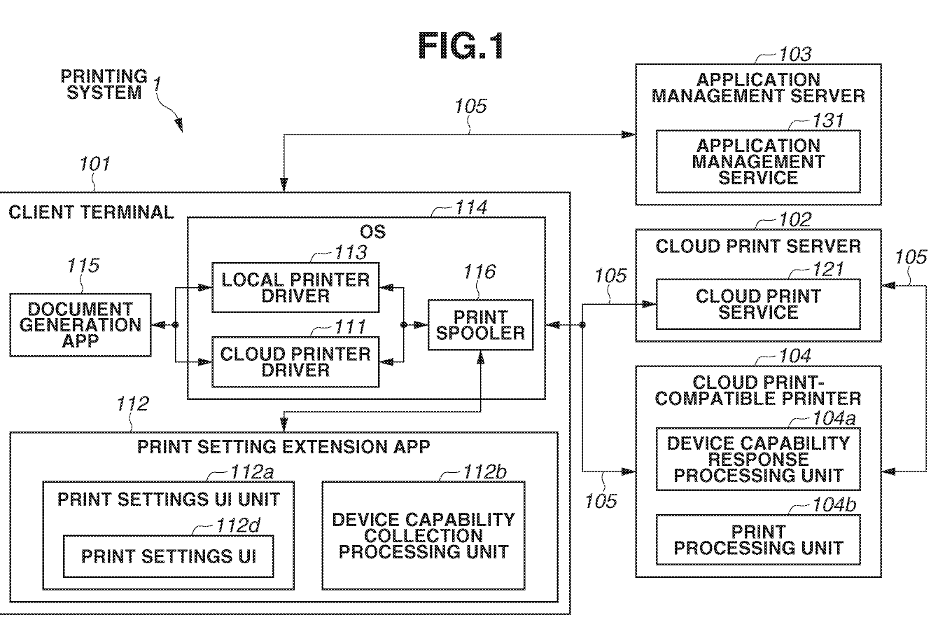

FIG. 1 is a diagram illustrating an example of the general configuration of a printing system including a client terminal as an information processing apparatus according to an embodiment of the present disclosure.

In a printing system 1, a client terminal 101, a cloud print server 102, an application management server 103, and a cloud print-compatible printer 104 (hereinafter referred to as the "printer 104") are connected together via a network 105 so that these apparatuses can communicate with each other.

Although FIG. 1 illustrates a single client terminal 101 and a single printer 104, a plurality of client terminals 101 and a plurality of printers 104 may be present.

The cloud print server 102 may be a server system including a plurality of information processing apparatuses. Consequently, it is possible to distribute load to the plurality of information processing apparatuses. Alternatively, the cloud print server 102 may be virtually configured within a physically single information processing apparatus.

Although it is assumed that the network 105 is a wide area network (WAN) such as the Internet or the like, the entirety of the network 105 may be a closed environment such as a company local area network (LAN) or the like.

The client terminal 101 is an information processing apparatus such as a personal computer (PC), a tablet, a smartphone, or the like and is a terminal directly operated by a user. Any application software can be executed on the client terminal 101.

A local printer driver 113 and a cloud printer driver 111 are printer drivers provided by a provider of an operating system (OS) 114 of the client terminal 101. Each of the drivers 113 and 111 is a class driver compliant with the Internet Printing Protocol (IPP) and capable of generating print data that can be interpreted by printers of a plurality of different printer vendors and transmitting the print data to any of the printers of the plurality of printer vendors. Each of the local printer driver 113 and the cloud printer driver 111 is provided with the OS 114 and can also be regarded as a printing-related function of the OS 114.

The local printer driver 113 is a printer driver used to connect the printer 104 and the client terminal 101 not via a server. Examples of the local printer driver 113 include Windows (registered trademark) IPP Class Driver.

The cloud printer driver 111 is a printer driver used to use a cloud print service 121 in the cloud print server 102 provided by the OS vendor. Examples of the cloud printer driver 111 include Windows (registered trademark) Universal Print (UP) Class Driver.

To use cloud printing, information regarding the printer 104 is registered in advance in the cloud print service 121. The client terminal 101 specifies the printer 104 as an output destination of print data generated by the cloud printer driver 111 and transmits the print data to the cloud print service 121. The cloud print service 121 transmits the print data to the printer 104 specified by the client terminal 101, thereby executing printing.

When the client terminal 101 is shipped, the local printer driver 113 and the cloud printer driver 111 are already stored in a storage unit 214 of the client terminal 101.

A print spooler 116 is a printing-related function provided by the OS 114 and has a function of storing intermediate data and print data received from the local printer driver 113 or the cloud printer driver 111 in a temporary storage area. The print data stored in the temporary storage area is called by a print setting extension app 112 or transmitted to the cloud print server 102 or the printer 104.

In the specification, the printing-related functions provided by the OS 114, such as the cloud printer driver 111, the local printer driver 113, and the print spooler 116, are also occasionally referred to collectively as "print software". The subject of the operation of the print software is also occasionally represented as the OS 114.

A print setting extension app 112 (an application program) is a print setting application provided by a vendor who is one of the plurality of printer vendors (manufacturers or producers) and provides a printer for use in printing.

The print setting extension app 112 is an app that collaborates with the local printer driver 113 and the cloud printer driver 111 to support the local printer driver 113 and the cloud printer driver 111. The print setting extension app 112 is termed Print Support Application (PSA) in Windows (registered trademark).

Although in the present embodiment, the print setting extension app 112 is stored in the storage unit 214 when the client terminal 101 is shipped, the present disclosure is not limited to this. If the print setting extension app 112 is not stored in the storage unit 214 when the client terminal 101 is shipped, the print setting extension app 112 is downloaded from the application management server 103 via the network 105 by a predetermined user operation on the client terminal 101. The print setting extension app 112 extends functions regarding the print settings of the local printer driver 113 and the cloud printer driver 111 via the print spooler 116 of the OS 114.

The printer 104 is a printing apparatus that performs actual printing on a recording medium such as a sheet or the like. A device capability response processing unit 104a manages device capability information regarding the printer 104 and notifies the client terminal 101 of the capability information according to a request from the client terminal 101. A print processing unit 104b converts print data received directly or via the network 105 from the client terminal 101 into image data and prints the image data.

A print settings user interface (UI) unit 112a provides a print settings UI 112d extended by the printer vendor to the user in the print setting extension app 112.

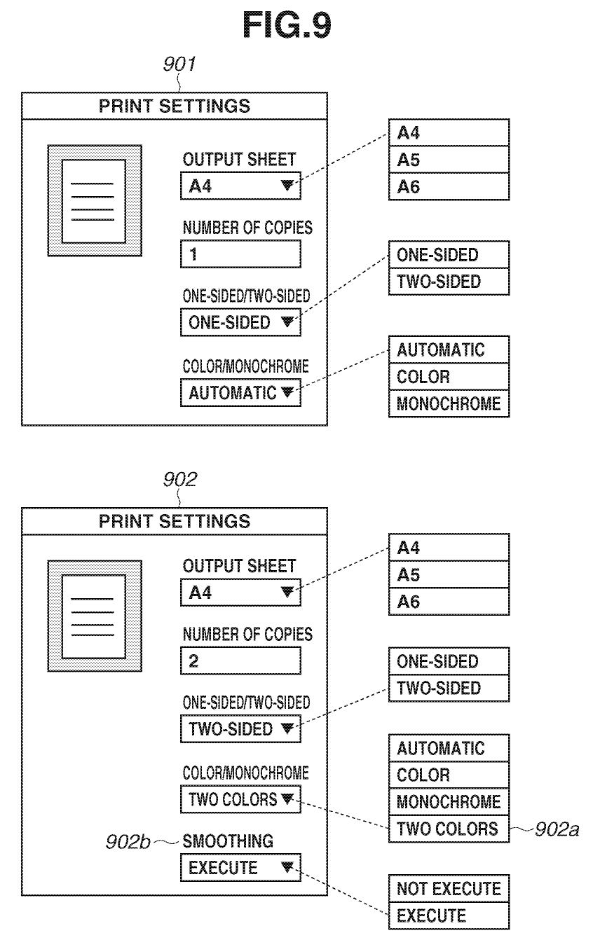

Specifically, the print settings UI unit 112a generates the print settings UI 112d based on capability information acquired from the cloud print service 121 by the OS 114 and the print setting extension app 112 and displays the print settings UI 112d. A print function setting screen as an example of the print settings UI 112d will be described below with reference to FIG. 9.

A device capability collection processing unit 112b is a module that causes the OS 114 to operate, thereby collecting capability information regarding the printer 104, and based on the collected capability information, updating device capability information managed by the OS 114.

A document generation app 115 is general applications such as a document file generation app, a spreadsheet app, a presentation app, a web browser, and the like. These applications may be pre-installed on the OS 114, or may be downloaded and installed by the user.

The cloud print server 102 is a server apparatus that provides the cloud print service 121 provided by the OS vendor. In the present embodiment, the cloud print server 102 receives a print instruction and print data from the client terminal 101. Then, the cloud print server 102 transmits the received print data to the printer 104, thereby providing the service to the user.

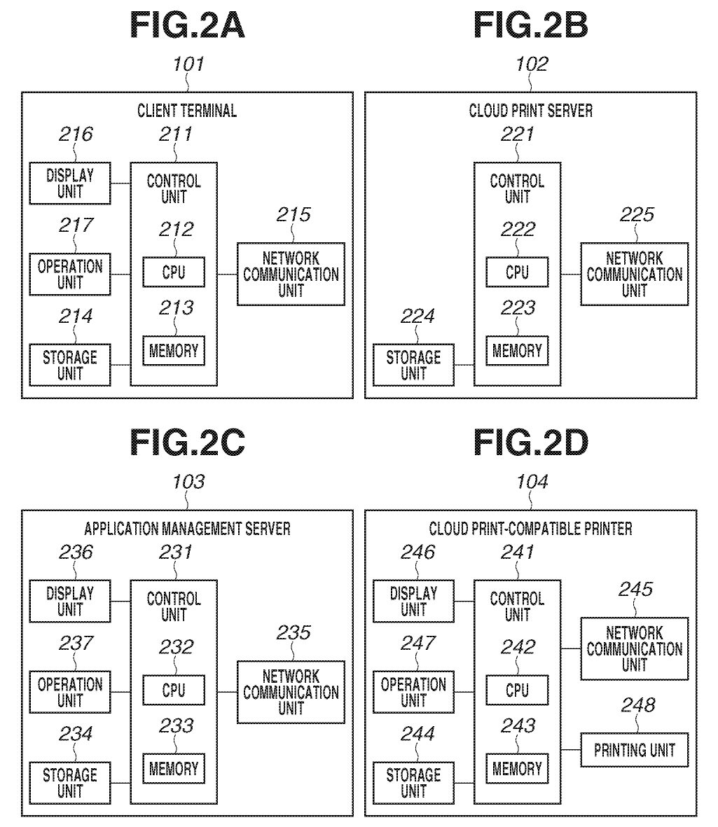

Next, with reference to FIGS. 2A to 2D, the hardware configurations of modules of the printing system 1 are described.

FIG. 2A is a block diagram illustrating the hardware configuration of the client terminal 101.

The client terminal 101 includes a display unit 216, an operation unit 217, a storage unit 214, a control unit 211, and a network communication unit 215.

The storage unit 214 refers to a non-volatile storage device such as a hard disk, a solid-state drive (SSD), or the like and can store and rewrite digital data.

The control unit 211 includes a central processing unit (CPU) 212 and a memory 213 and controls the operation of the entirety of the client terminal 101. The CPU 212 loads a computer program stored in the storage unit 214 into the memory 213 and executes the computer program. The memory 213 is a main storage memory of the CPU 212 and is used as a work area or a temporary storage area into which various programs are loaded.

The network communication unit 215 is a device that communicates with the external network 105, and inputs and outputs digital data from and to an external server, the client terminal 101, or the like via the network 105.

The display unit 216 is a device that displays visual information to the user in real time, such as a liquid crystal display or the like. The operation unit 217 is a device that receives an input from the user through a keyboard, a mouse, and the like. A device having the functions of both the display unit 216 and the operation unit 217, such as a touch panel or the like, may be used.

FIG. 2B is a block diagram illustrating the hardware configuration of the cloud print server 102. The cloud print server 102 includes a storage unit 224, a control unit 221, and a network communication unit 225. The control unit 221 includes a CPU 222 and a memory 223.

The storage unit 224, the control unit 221, the network communication unit 225, the CPU 222, and the memory 223 have functions equivalent to those of the apparatuses having the same names included in the client terminal 101, and therefore are not described.

Although in the present embodiment, the cloud print server 102 includes a single information processing apparatus having the hardware configuration illustrated in FIG. 2B, the cloud print server 102 may include a plurality of information processing apparatuses as illustrated in FIG. 2B.

FIG. 2C is a block diagram illustrating the hardware configuration of the application management server 103. The application management server 103 includes a display unit 236, an operation unit 237, a storage unit 234, a control unit 231, and a network communication unit 235. The control unit 231 includes a CPU 232 and a memory 233.

The display unit 236, the operation unit 237, the storage unit 234, the control unit 231, the network communication unit 235, the CPU 232, and the memory 233 have functions equivalent to those of the apparatuses having the same names included in the client terminal 101, and therefore are not described.

Although in the present embodiment, the description is given on the assumption that the application management server 103 includes a single information processing apparatus having the hardware configuration illustrated in FIG. 2C, the application management server 103 may include a plurality of information processing apparatuses.

FIG. 2D is a block diagram illustrating the hardware configuration of the printer 104. The printer 104 includes a display unit 246, an operation unit 247, a storage unit 244, a control unit 241, a network communication unit 245, and a printing unit 248. The control unit 241 includes a CPU 242 and a memory 243.

The display unit 246 is a device that displays information to the user in real time, such as a touch panel, a light-emitting diode (LED), or the like provided in the printer 104.

The operation unit 247 is a device that receives an input from the user, and may include a hardware key such as a numeric keypad or the like in addition to a touch panel. The storage unit 244, the control unit 241, the CPU 242, and the memory 243 have functions equivalent to those of the apparatuses having the same names included in the client terminal 101, and therefore are not described.

The network communication unit 245 is a device that communicates with the external network 105, and has a function of mainly receiving print data and transmitting the state of the printer 104, such as an error or the like, to an external server or the like.

The printing unit 248 is a device that performs a printing process on a sheet prepared in a cassette or a tray by performing a series of operations such as sheet feeding, printing, and sheet discharge. The method of the printing is not particularly limited, and may be an electrophotographic method, an inkjet method, or the like. The printing unit 248 also includes a two-sided unit used when the sheet discharge is performed, and a finishing device that performs a stapling process, a punching process, and the like.

Although in the present embodiment, a single-function printer that performs only a print function is described as an example of the printer 104, a multifunction printer (a multifunction peripheral) also having a scanner function and a fax function may be used.

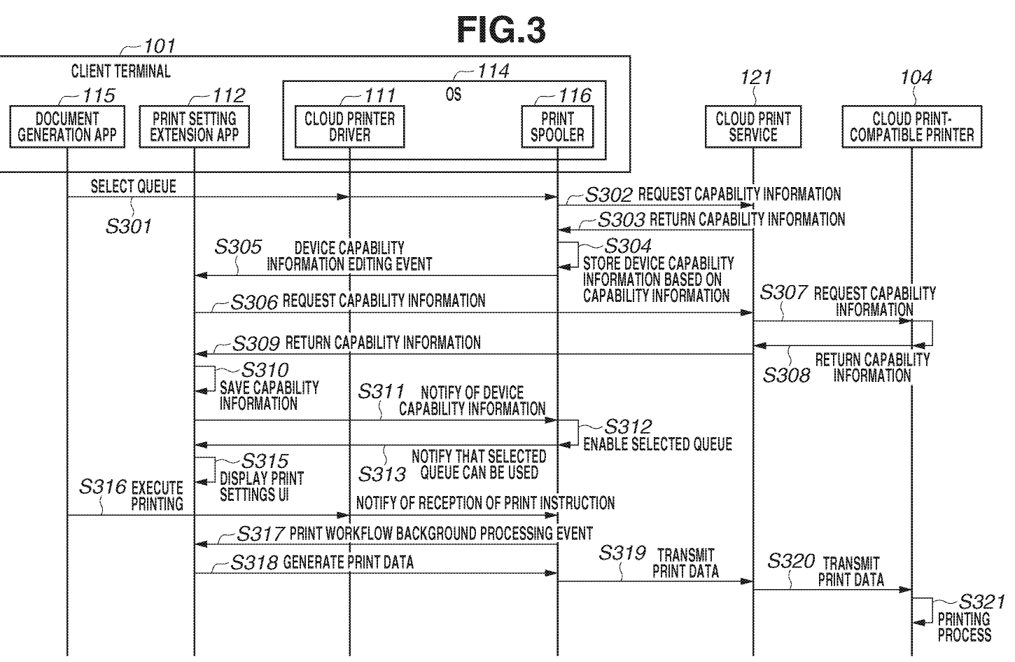

Next, with reference to FIG. 3, a description is given of an example of the sequence of processing that is executed by the modules of the printing system 1 and starts by the user selecting a print queue in the client terminal 101 according to the present embodiment.

FIG. 3 illustrates processing executed after information regarding the printer 104 is registered in the cloud print service 121 and the generation of a print queue is completed. In this case, a print queue for transmitting print data generated by the cloud printer driver 111 to the printer 104 via the cloud print service 121 is generated in advance. Alternatively, the cloud printer driver 111 may be read as the local printer driver 113, and the local printer driver 113 may directly communicate with the printer 104 not via the cloud print service 121.

In step S301, the print spooler 116 of the OS 114 receives the selection of a print queue by the user through a print settings UI provided by the document generation app 115.

Specifically, first, the user starts the document generation app 115 in the client terminal 101, opens an original document as a printing target using the document generation app 115, and selects "print" from a menu. The document generation app 115 receives this selection and displays an app print settings UI on the display unit 216.

The app print settings UI displays the printer names of printers that can print print data transmitted from the client terminal 101. If the user selects the printer name of a printer as a print destination of the original document as the printing target on the app print settings UI, the print spooler 116 determines that a print queue corresponding to the selected printer name is selected by the user. Alternatively, the print queue may be selected on an OS print settings UI provided by the OS 114 and different from the app print settings UI provided by the document generation app 115.

In the present embodiment, a case is described where the printer name of the printer 104 as a cloud printer that prints print data via the cloud print service 121 is selected by the user on the app print settings UI in step S301.

If the print queue is selected, the print spooler 116 reads a print ticket. A "print ticket" refers to a file indicating print setting information describing current print settings in the Extensible Markup Language (XML) format and is managed with respect to each print queue. The print ticket describes the print settings in a format that can be interpreted by the OS 114. Each of the print settings is described as a set of a setting item and a setting value.

Next, in step S302, the print spooler 116 transmits to the cloud print service 121 an acquisition request to acquire capability information regarding the printer (the printer 104 in this case) corresponding to the print queue selected by the user and received in step S301.

In the acquisition request, a Get-Printer-Attributes command defined by the IPP is used. At this time, attribute information corresponding to a setting item is set as an argument of the command, whereby the print spooler 116 can acquire capability information regarding a setting item specified by the print spooler 116. In the present embodiment, attribute information and an attribute value are information exchanged according to the IPP.

In step S303, the cloud print service 121 returns the capability information regarding the printer 104 as a response to the print spooler 116 of the OS 114.

In step S304, the print spooler 116 of the OS 114 stores the capability information acquired as the response from the cloud print service 121 in step S303 as device capability information associated with the print queue for the printer 104.

In step S305, the print spooler 116 of the OS 114 notifies the device capability collection processing unit 112b of the print setting extension app 112 of an event indicating that the device capability information can be edited (a device capability information editing event).

At the timing when the device capability collection processing unit 112b receives the device capability information editing event from the print spooler 116 in step S305, the device capability collection processing unit 112b can use an application programming interface (API) for the OS 114. The API is an API for editing the device capability information.

If the device capability collection processing unit 112b receives the device capability information editing event from the print spooler 116 in step S305, then in step S306, the device capability collection processing unit 112b requests the capability information regarding the printer 104 from the cloud print service 121.

Specifically, the device capability collection processing unit 112b makes the request in step S306 to the cloud print service 121 by setting attribute information selected as a request target, using a standard protocol such as Get-Printer-Attributes defined by the IPP.

The print setting extension app 112 can also acquire capability information regarding attribute information not supported by the OS 114. In the present embodiment, printer vendor-specific attribute information is set as arguments of Get-Printer-Attributes used for the request in step S306, whereby the print setting extension app 112 can also acquire capability information regarding attribute information not defined by the IPP.

In step S307, the cloud print service 121 having received the request for the capability information in step S306 requests the capability information from the printer 104 using the IPP. Specifically, in step S307, the cloud print service 121 inquires about the capability information regarding the printer 104 using Get-Printer-Attributes. At this time, the cloud print service 121 inquires of the printer 104 using arguments of which the cloud print service 121 is notified by the client terminal 101.

In step S308, the printer 104 returns the capability information requested by the cloud print service 121 in step S307 as a response. If the cloud print service 121 receives the capability information from the printer 104 in step S308, then in step S309, based on the content of the received response, the cloud print service 121 returns the capability information requested in step S306 by the print setting extension app 112 as a response.

In step S310, the print setting extension app 112 duplicates and stores the capability information acquired by the OS 114 in steps S306 to S309 and steps S302 and S303 as device capability information data in a data storage area of the print setting extension app 112.

Next, in step S311, the print setting extension app 112 notifies the print spooler 116 of the OS 114 of the device capability information data.

If the print spooler 116 receives the device capability information data from the print setting extension app 112, then in step S312, the print spooler 116 enables the print queue selected in step S301.

Consequently, it is possible to start the print settings UI unit 112a of the print setting extension app 112.

If the print queue is enabled in step S312, then in step S313, the print spooler 116 notifies the print setting extension app 112 that the print queue can be used. The OS 114 notifies the document generation app 115 that the print queue can be used.

If the document generation app 115 receives the notification, then in step S315, the document generation app 115 displays an advanced settings button and a print button on the currently displayed app print settings UI so that these buttons can be selected. If the advanced settings button is selected by the user, the document generation app 115 displays the print settings UI 112d of the print setting extension app 112.

If the document generation app 115 receives a print instruction (the selection of the print button) from the user through the app print settings UI, then in step S316, the document generation app 115 transmits a print execution instruction including image data as a printing target to the cloud printer driver 111 of the OS 114. If the cloud printer driver 111 receives the print execution instruction from the document generation app 115, the cloud printer driver 111 notifies the print spooler 116 of the reception of the print execution instruction.

If the print spooler 116 receives the notification regarding the reception of the print execution instruction from the cloud printer driver 111 in step S316, then in step S317, the print spooler 116 notifies the print setting extension app 112 of a print workflow background processing event.

The "print workflow background processing event" refers to the process of starting a print workflow background process of the print setting extension app 112. The "print workflow background process" refers to the process in which the print setting extension app 112 gives an instruction to the cloud printer driver 111 via the print spooler 116 of the OS 114.

The print spooler 116 can generate intermediate image data from data (e.g., image data in the Graphics Device Interface (GDI) format) received from the document generation app 115 via the cloud printer driver 111 and further convert the intermediate image data into page description language (PDL) data. The "intermediate image data" refers to data generated before being converted into print data such as PDL data (e.g., XML Paper Specification (XPS) data).

In step S318, the print setting extension app 112 generates print data using the print spooler 116.

In step S319, the print spooler 116 of the OS 114 passes the print data to the cloud print service 121. In step S320, the cloud print service 121 transmits the passed print data to the printer 104. Then, in step S321, the printer 104 having received the print data performs a printing process, and this processing (FIG. 3) ends.

### Request for Capability Information by Client Terminal and Response of Capability Information from Printer

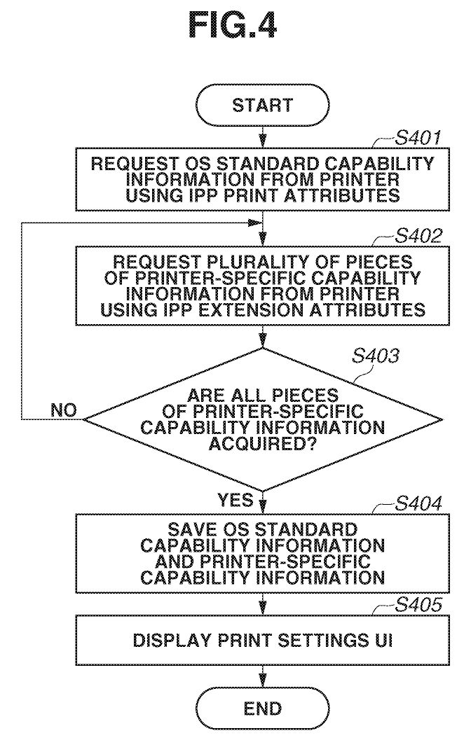

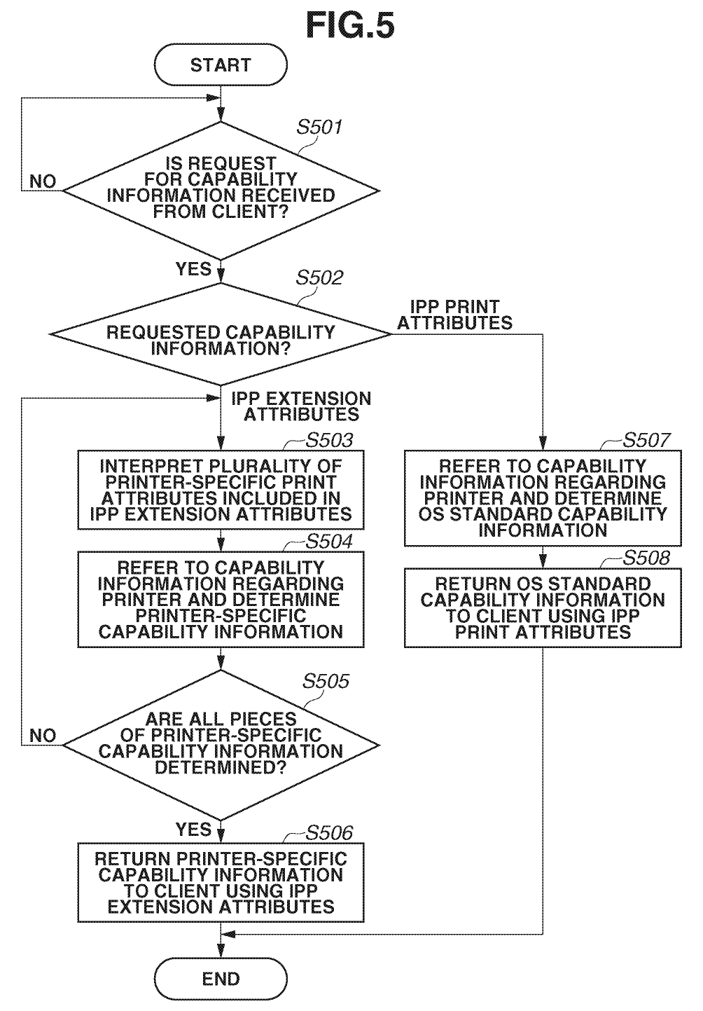

With reference to FIGS. 4 and 5, a description is given of the details of processing performed by (the print setting extension app 112 of) the client terminal 101 and processing performed by the printer 104, respectively, in steps S306 to S315.

### Request for Capability Information by Client Terminal

First, the print setting extension app 112 of the client terminal 101 has a mapping table associating OS standard print attributes defined by the IPP with print attributes used in an actual printing process by the printer 104 in the data storage area of the print setting extension app 112.

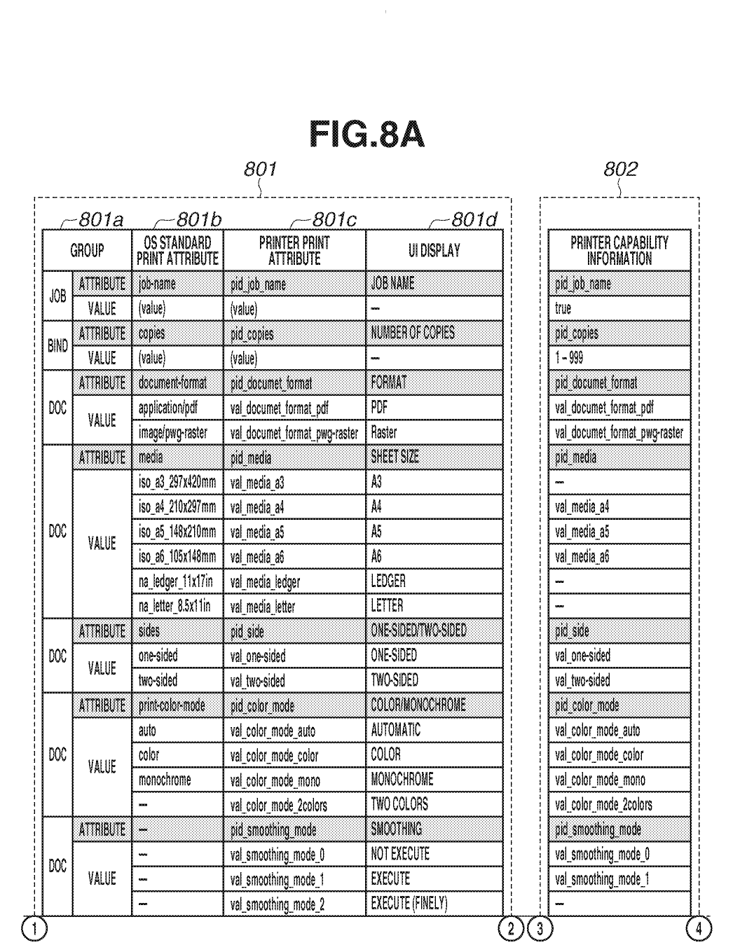

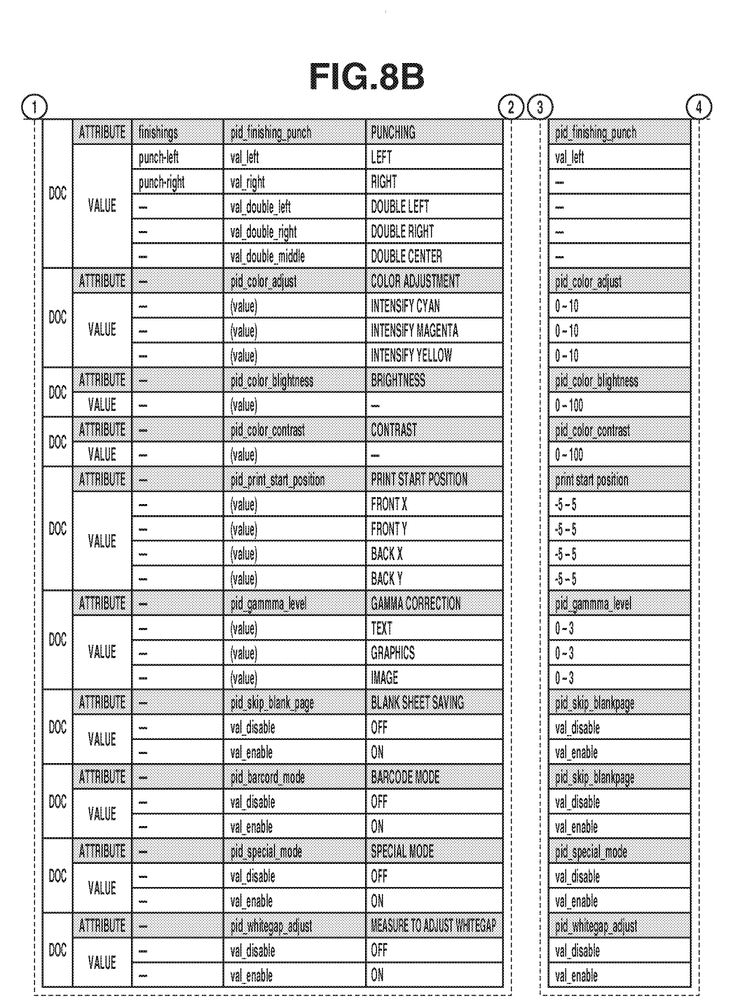

FIGS. 8A and 8B illustrate examples of a mapping table 801. OS standard print attributes 801b defined by the IPP and printer print attributes 801c used in a printer printing process by the printer 104 are basically associated one-on-one with each other.

The printer 104, however, also has printer-specific print functions not defined by the IPP, and therefore, some of the printer print attributes 801c is not associated with any OS standard print attribute 801b. In the mapping table 801 in FIGS. 8A and 8B, such printer print attributes 801c correspond to an attribute value of a pid_color_mode attribute, namely val_color_mode_2colors, and a pid_smoothing_mode attribute and attribute values of the pid_smoothing_mode attribute.

In the present embodiment, the OS standard print attributes 801b and the printer print attributes 801c are classified into groups 801a determined in advance according to targets specified by the attributes.

An attribute indicating the specifying of the entirety of print data (= a job), such as a job name (job-name or pid_job_name), is classified into a JOB group.

An attribute indicating the specifying of a print document, such as color/monochrome printing (print-color-mode or pid_color_mode), is classified into a DOC group.

An attribute indicating the specifying of a finishing process on a print product, such as the number of copies (copies or pid_copies) or finishings (punching, stapling, and the like (not illustrated)), is classified into a BIND group.

The print setting extension app 112 also has information regarding UI display 801d indicating how to display each attribute of the OS standard print attributes 801b and the printer print attributes 801c on a UI. Thus, the print setting extension app 112 can display an appropriate print settings UI (step S315) according to saved capability information (step S310).

With reference to FIG. 4, a description is given below of the details of the processing performed by the print setting extension app 112. The processing illustrated in FIG. 4 starts according to the reception of the selection of a print queue by the user through the print settings UI 112d provided by the document generation app 115.

In step S401, the print setting extension app 112 requests OS standard capability information using Get-Printer-Attributes defined by the IPP standard protocol.

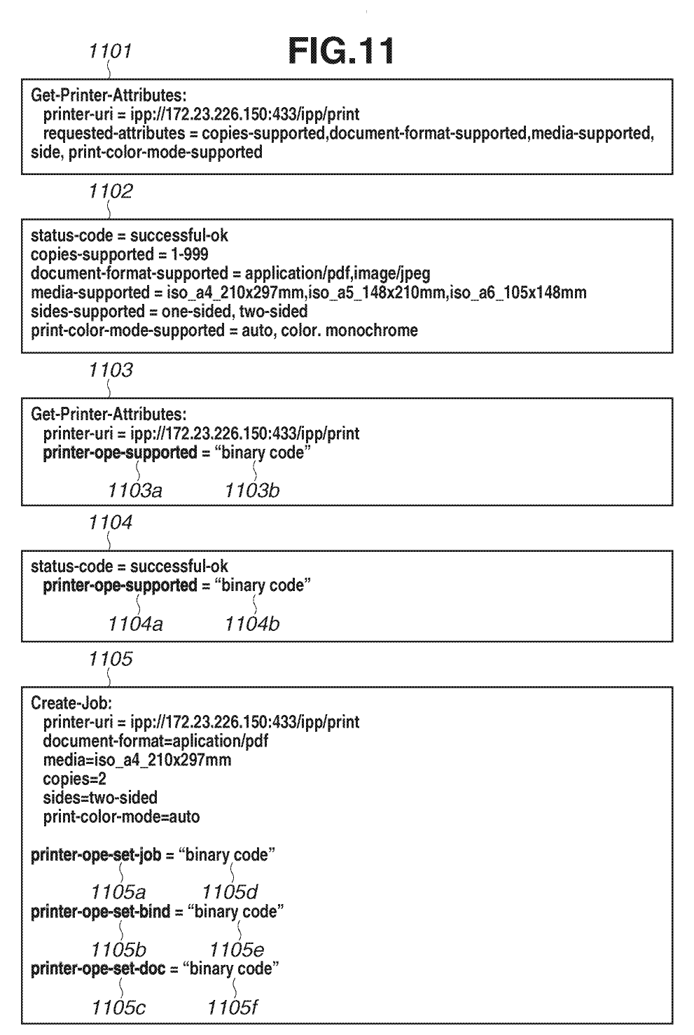

FIG. 11 illustrates examples of an IPP command 1101 to request OS standard capability information and an IPP command 1102 to return capability information as a response to the request. The IPP command 1101 to request capability information requests the following capability information from a printer specified by printer-uri.
copies-supported (the number of copies that can be specified)
document-format-supported (a supported document format)
media-supported (a supported sheet)
sides-supported (one-sided/two-sided printing)
print-color-mode-supported (monochrome/color printing)

The IPP command 1102 to return capability information as a response includes information indicating the success of the response to the request (successful-ok) and returns the requested capability information as follows.
The number of copies that can be specified is 1 to 999.
The supported document is PDF and JPEG.
The supported sheet is an A4 sheet, an A5 sheet, and an A6 sheet.
One-sided printing and two-sided printing are possible.
Automatic, color, and monochrome printing is possible.

If the print setting extension app 112 saves only this OS standard capability information (step S310) and displays a UI (step S315), the UI is as illustrated in print settings 901 in FIG. 9. The present embodiment, however, includes the processes of step S402 and subsequent steps, and therefore, the UI allows print settings broader than the print settings 901.

In step S402, the print setting extension app 112 requests pieces of printer-specific capability information using Get-Printer-Attributes defined by the IPP standard protocol.

FIG. 11 illustrates examples of an IPP command 1103 to request printer-specific capability information and an IPP command 1104 to return capability information as a response to the request.

The IPP command 1103 introduces a printer-ope-supported attribute 1103a as an IPP extension attribute to achieve a request for printer-specific capability information to the printer specified by printer-uri and a response of printer-specific capability information from the printer specified by printer-uri. An IPP extension attribute is an attribute defined by the vendor (the manufacturer) of the printer 114.

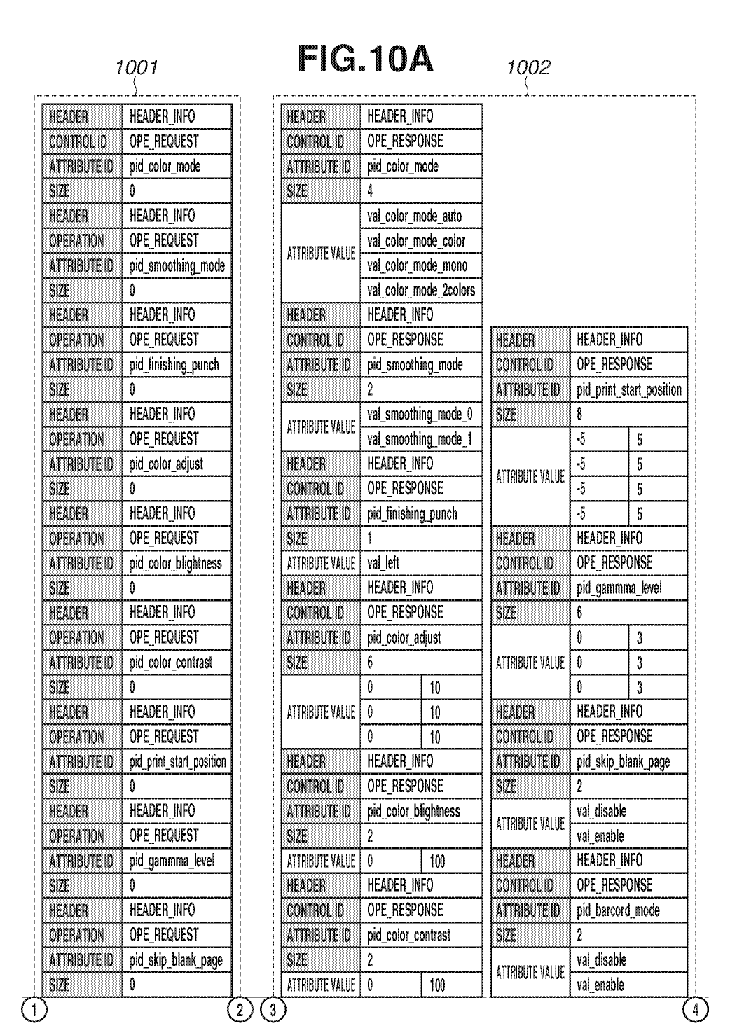

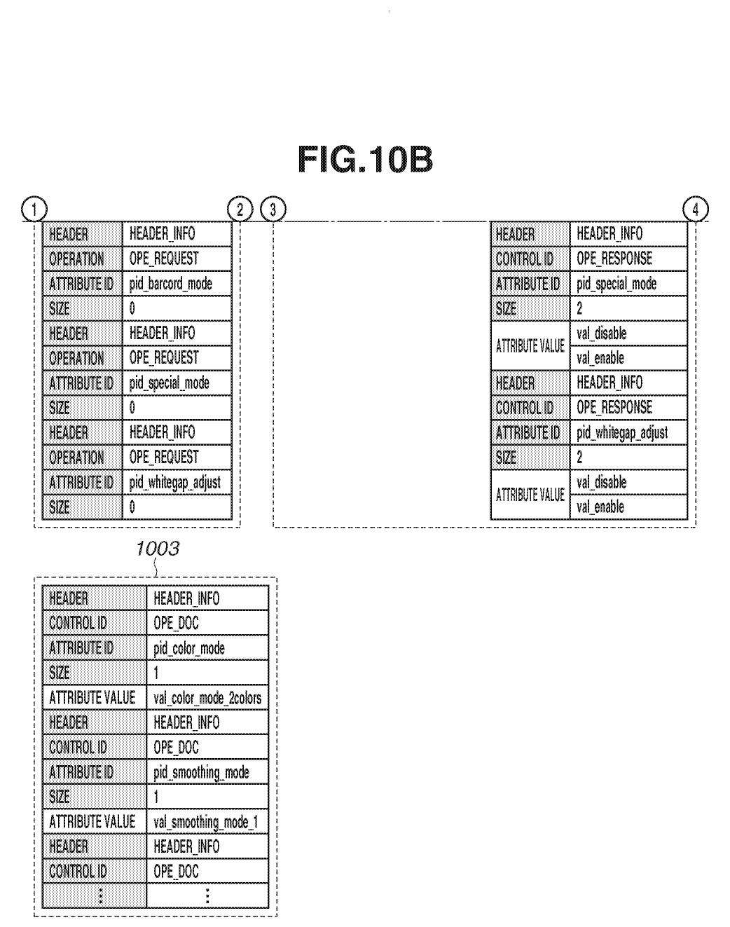

Although the attribute value of printer-ope-supported is described as "binary code" (1103b) in FIG. 11, the true state of "binary code" is a binary 1001 having a structure illustrated in FIGS. 10A and 10B. The binary 1001 includes a request for a plurality of pieces of printer-specific capability information (pid_color_mode and pid_smoothing_mode). The details of the structure of the binary 1001 will be described below.

The IPP command 1104 to return capability information as a response includes information indicating the success of the response to the request (successful-ok). Similarly to the IPP command 1103 to request capability information, the IPP command 1104 introduces a printer-ope-supported attribute 1104a obtained by extending the IPP to achieve a request for printer-specific capability information and a response of printer-specific capability information.

Although the attribute value of printer-ope-supported is described as "binary code" similarly to the IPP command 1103 to request capability information, the true state of "binary code" is a binary attribute value 1002 having a structure illustrated in FIGS. 10A and 10B. The attribute value 1002 includes a response of a plurality of pieces of printer-specific capability information (pid_color_mode and pid_smoothing_mode). The details of the structure of the binary attribute value 1002 will be described below.

In step S403, the print setting extension app 112 confirms whether all the pieces of printer-specific capability information are acquired. If all the pieces of printer-specific capability information are acquired (YES in step S403), the processing proceeds to step S404. If all the pieces of printer-specific capability information are not acquired (NO in step S403), the processing returns to step S402, and the process of step S402 is continued.

In step S404, the print setting extension app 112 duplicates and stores the acquired OS standard capability information and printer-specific capability information as device capability information data in the data storage area of the print setting extension app 112. In step S405, the print setting extension app 112 refers to the OS standard capability information and the printer-specific capability information and displays the print settings UI 112d.

In the case of the present embodiment, the UI is as illustrated in print settings 902 in FIG. 9. An option 902a for two-color printing, an item 902b of smoothing, and options 902c for the item 902b are newly displayed compared to the UI 901 in a case where only the OS standard capability information is referred to.

A description is given of the details of attribute values (the binary 1001) when the print setting extension app 112 requests pieces of printer-specific capability information, and attribute values (the binary attribute value 1002) in a response to the request in step S402.

The content of each of the attribute values (the binary attribute values 1001 and 1002) is composed of a print control command that can be interpreted by the printer 104. In the present embodiment, the content of the attribute value is composed of header information indicating the print control command, a control identifier (ID) indicating the content of the control, an attribute ID indicating a print attribute, size information regarding the attribute value of the print attribute, and an actual attribute value. The header information is any unique value determined in advance. The control ID is also an ID determined in advance. In the case of the present embodiment, a control ID "OPE_REQUEST" included in the binary 1001 indicates that this print control command is a capability request.

On the other hand, a control ID "OPE_RESPONSE" included in the binary attribute value 1002 indicates that this print control command is a capability response to the capability request. That is, using the binary 1001, the print setting extension app 112 inquires of the printer 104 about whether the printer 104 is a color printer or a monochrome printer (pid_color_mode) and whether the printer 104 supports a smoothing function (pid_smoothing_mode).

In response to the inquiry, using the binary attribute value 1002, the printer 104 notifies the print setting extension app 112 that the printer 104 is a printer that allows the selection of "automatic", "color", "monochrome", and "two-color printing", and supports a "smoothing" function including "not execute" and "execute" as options.

### Response of Capability Information from Printer

Next, with reference to FIG. 5, a description is given of the details of the processing performed by the printer 104 in steps S307 and S308.

In step S501, the device capability response processing unit 104a confirms whether a request for capability information is received from the client terminal 101 or the cloud print service 121. If a request for capability information is received (YES in step S501), the processing proceeds to step S502. If not (NO in step S501), the process of step S501 is continued.

In step S502, the device capability response processing unit 104a determines whether the request is a request for capability information using IPP extension attributes or a request for capability information using IPP print attributes. If the request is a request for capability information using the IPP extension attributes, the processing proceeds to step S503. If the request is a request for capability information using the IPP print attributes, the processing proceeds to step S507.

In step S503, the device capability response processing unit 104a interprets a plurality of printer-specific print attributes included in the attribute values of the IPP extension attributes. In the case of the present embodiment, the attribute value 1103b (the binary 1001) of the extension attribute 1103a includes at least the printer-specific print attributes pid_color_mode and pid_smoothing_mode.

In step S504, the device capability response processing unit 104a refers to capability information regarding the printer 104 held in the printer 104 and determines capability information to be returned as a response to the client terminal 101. FIGS. 8 A and 8B illustrate printer capability information 802 as an example of the capability information regarding the printer 104 held in the printer 104 in the present embodiment.

Referring to the printer capability information 802, the printer 104 supports the function (color/monochrome) indicated by the print attribute pid_color_mode. Moreover, the printer 104 allows the selection of val_color_mode_auto (automatic), color (color), mono (monochrome), and 2colors (two colors). Thus, the device capability response processing unit 104a determines these pieces of capability information as capability information to be returned as a response to the client terminal 101.

The printer 104 also supports the function (smoothing) indicated by the print attribute pid_smoothing_mode and allows the selection of val_smoothing_mode_0 (not execute) and 1 (execute). Thus, the device capability response processing unit 104a determines these pieces of capability information as capability information to be returned as a response to the client terminal 101.

In step S505, the device capability response processing unit 104a confirms whether all the pieces of capability information is determined regarding the plurality of requested printer-specific print attributes. If all the pieces of capability information are determined (YES in step S505), the processing proceeds to step S506. If all the pieces of capability information are not determined (NO in step S505), the processes of step S503 and the subsequent steps are repeated.

In step S506, the device capability response processing unit 104a notifies the client terminal 101 of the printer-specific capability information using the IPP extension attributes.

In the case of the present embodiment, an attribute value 1104b (the binary attribute value 1002) of the extension attribute 1104a includes the printer-specific print attribute pid_color_mode and the attribute values (val_color_mode_auto, color, mono, and 2colors) of the printer-specific print attribute pid_color_mode. The attribute value 1104b (the binary attribute value 1002) also includes the printer-specific print attribute pid_smoothing_mode and the attribute values (val_smoothing_mode_0 and 1) of the printer-specific print attribute pid_smoothing_mode. The attribute value 1104b (the binary attribute value 1002) may include only one of these attributes, or may include only a print attribute other than these attributes and the attribute values of the print attribute.

A description is given of processing in a case where it is determined in step S502 that a request for capability information using the IPP print attributes is received. In step S507, the device capability response processing unit 104a refers to the IPP print attributes and the capability information regarding the printer 104 held in the printer 104 and determines OS standard capability information to be returned as a response to the client terminal 101.

In the case of the present embodiment, the IPP command 1101 to request capability information requests the capability information regarding copies-supported (the number of copies that can be specified), document-format-supported (the supported document format), media-supported (the supported sheet), sides-supported (one-sided/two-sided printing), and print-color-mode-supported (monochrome/color printing).

In step S508, the device capability response processing unit 104a notifies the client terminal 101 of the OS standard capability information using the IPP print attributes. In the case of the present embodiment, the device capability response processing unit 104a notifies the client terminal 101 of the print attributes indicated by the IPP command 1102 to return capability information as a response and the attribute values of the print attributes. The details have been described in step S401 in FIG. 4, and therefore are not described here.

Transmission of Print Data from Client Terminal and Printing Process by Printer

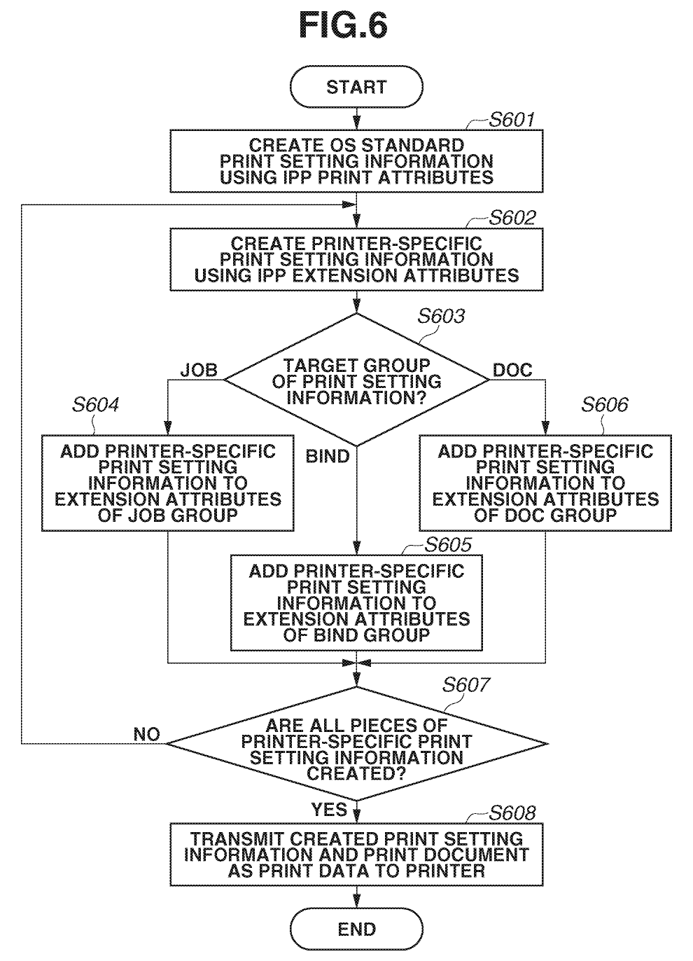

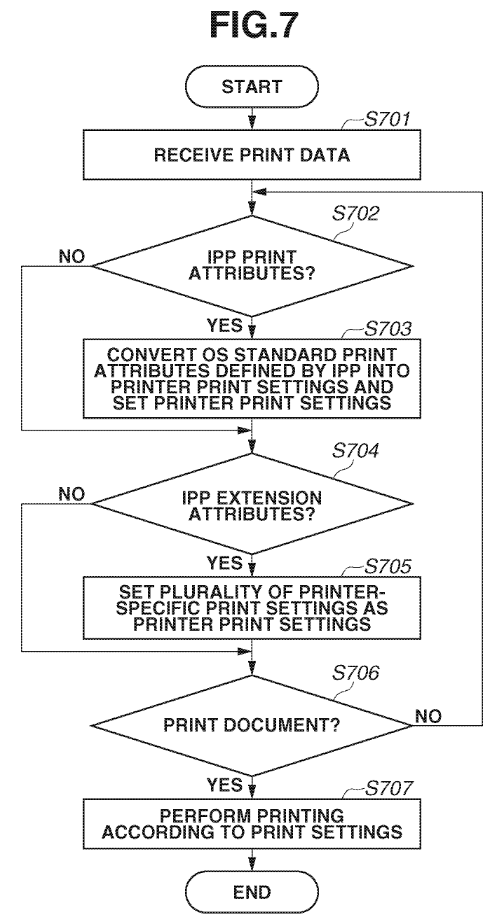

With reference to FIGS. 6 and 7, a description is given of the details of the print data generation process performed by the print setting extension app 112 of the client terminal 101 in step S318 and the printing process performed by the printer 104 in step S321, respectively.

### Transmission of Print Data from Client Terminal

First, with reference to FIG. 6, a description is given of the print data generation process performed by the print setting extension app 112 of the client terminal 101 in step S318.

In step S601, the print setting extension app 112 creates OS standard print setting information using the IPP print attributes according to print settings when printing is performed. If the print settings according to the present embodiment are the print settings 902 in FIG. 9, the created OS standard print setting information is as follows (see the OS standard print attributes 801b in FIGS. 8 A and 8B).
media (output sheet) = iso_a4_210×297mm (A4)
copies (number of copies) = 2
sides (one-sided/two-sided) = two-sided (two-sided)
print-color-mode (color/monochrome) = auto (automatic)

Although the color/monochrome setting in the print settings 902 is "two colors", the attribute values of print-color-mode defined in the OS standard print attributes 801b are only "auto (automatic)", "color (color)", and "monochrome (monochrome)".

Thus, in the present embodiment, auto (automatic) is set as a default value in print-color-mode.

In step S602, the print setting extension app 112 creates printer-specific print setting information using the IPP extension attributes according to the print settings when printing is performed. In the present embodiment, to create the printer-specific print setting information, attributes obtained by extending the IPP as illustrated in FIG. 11 are introduced. That is, a printer-ope-set-job attribute (1105a), a printer-ope-set-bind attribute (1105b), and a printer-ope-set-doc attribute (1105c) are introduced.

The printer-ope-set-job attribute (1105a) includes print setting information regarding the entirety of print data (= a job), such as a job name. The printer-ope-set-bind attribute (1105b) includes print setting information regarding a finishing process on a print product, such as the number of copies or finishings (punching, stapling, and the like). Then, the printer-ope-set-doc attribute (1105c) includes print setting information regarding a print document, such as color/monochrome printing.

The attribute value of each of the extension attributes is described as "binary code" (1105d, 1105e, or 1105f). However, the true state of "binary code" is a binary having the same structure as those of the binaries (1103b and 1104b) of the IPP command 1103 to request capability information and the IPP command 1104 to return capability information as a response.

If the print settings according to the present embodiment are the print settings 902 in FIG. 9, the created printer-specific print setting information is as follows (see the printer print attributes 801c in FIGS. 8 A and 8B).
pid_color_mode (color/monochrome)
= val_color_mode_2colors (two colors)
pid_smoothing_mode (smoothing)
= val_smoothing_mode_1 (execute)

FIGS. 10A and FIG. 1B illustrate a binary 1003 having a binary structure where these pieces of printer-specific print setting information are the attribute values of the extension attributes. A control ID is an ID determined in advance. In the case of the present embodiment, a control ID "OPE_DOC" included in the binary 1003 indicates that this print control command is print settings for the DOC group (see the information 801a).

In step S603, the print setting extension app 112 confirms a target group of the created print setting information. If the target is the JOB group, the processing proceeds to step S604. If the target is the BIND group, the processing proceeds to step S605. If the target is the DOC group, the processing proceeds to step S606.

In step S604, the print setting extension app 112 adds the print setting information created in step S602 to the attribute values of the printer-ope-set-job attribute (1105a).

In step S605, the print setting extension app 112 adds the print setting information created in step S602 to the attribute values of the printer-ope-set-bind attribute (1105b).

In step S606, the print setting extension app 112 adds the print setting information created in step S602 to the attribute values of the printer-ope-set-doc attribute (1105c). In the present embodiment, the created printer-specific print setting information (the binary 1003) is print settings for the DOC group and therefore is added as the attribute values of the printer-ope-set-doc attribute (1105c) in step S606.

As described above, the attribute values of the extension attributes (the print setting information) are classified into the same target group, whereby it is possible to decrease the load on the printer 104 when interpreting the attribute values of the extension attributes and performing the printing process later.

If the print setting extension app 112 adds the print setting information to the appropriate group in step S604, S605, or S606, the processing proceeds to step S607. In step S607, the print setting extension app 112 confirms whether all the pieces of printer-specific print setting information are created. If all the pieces of printer-specific print setting information are created (YES in step S607), the processing proceeds to step S608. If all the pieces of printer-specific print setting information are not created (NO in step S607), the processes of step S602 and the subsequent steps are repeated.

In step S608, the print setting extension app 112 transmits the OS standard print setting information and the printer-specific print setting information with a print document as print data to the printer 104. The OS 114 is instructed to create print data using a Create-Job command defined by the IPP. At this time, the print setting information can be set as arguments of the command. An IPP command 1105 in FIG. 11 is an example of the Create-Job command according to the present embodiment.

### Printing Process by Printer

Next, with reference to FIG. 7, a description is given of the printing process performed by the printer 104 in step S321.

In step S701, the print processing unit 104b of the printer 104 receives print data.

In step S702, if the print processing unit 104b confirms IPP print attributes in the print data (YES in step S702), the processing proceeds to step S703. If not (NO in step S702), the processing proceeds to step S704.

In step S703, the print processing unit 104b converts the OS standard print attributes defined by the IPP into printer print settings to be used by the printer 104 and sets the printer print settings. In this case, similarly to the client terminal 101, the printer 104 according to the present embodiment has the mapping table 801 associating the OS standard print attributes 801b with the printer print attributes 801c used in an actual printing process by the printer 104 in a data storage area of the printer 104.

In the case of the present embodiment, the OS standard print settings created in step S601 in FIG. 6 by the client terminal 101:
media (output sheet) = iso_a4_210×297mm (A4)
copies (number of copies) = 2
sides (one-sided/two-sided) = two-sided (two-sided)
print-color-mode (color/monochrome) = auto (automatic)

are converted as follows based on the mapping table 801 and set as printer print settings.

pid_media (output sheet) = val_media_a4 (A4)
pid_copies (number of copies) = 2
pid_side (one-sided/two-sided) = val_two-sided (two-sided)
pid_color_mode (color/monochrome) = val_color_mode_auto (automatic)

A target group of these print settings is any of the JOB, BIND, and DOC groups, and the target group is determined based on the groups 801a in the mapping table 801.

In step S704, if the print processing unit 104b confirms that IPP extension attributes are present in the print data (YES in step S704), the processing proceeds to step S705. If not (NO in step S704), the processing proceeds to step S706.

In step S705, the print processing unit 104b sets the printer-specific print settings included in the attribute values of the extension attributes as printer print settings. In the case of the present embodiment, the attribute values (the binary 1003) created in step S602 in FIG. 6 by the client terminal 101 are set as printer print settings.
pid_color_mode (color/monochrome) = val_color_mode_auto (automatic)
pid_smoothing_mode (smoothing) = val_smoothing_mode_1 (execute)

At this time, in step S705, auto (automatic) in pid_color_mode set in step S703 is overwritten with val_color_mode_2colors (two colors). This means that the printer-specific print setting information is given priority over the OS standard print setting information.

Target groups of these print settings are determined based on the extension attributes. If the extension attributes are printer-ope-set-job, the target of all the print settings included in the attribute values of the extension attributes is the JOB group. If the extension attributes are printer-ope-set-bind, the target of all the print settings included in the attribute value of the extension attributes is the BIND group. If the extension attributes are printer-ope-set-doc, the target of a plurality of print settings included in the attribute values of the extension attributes is the DOC group.

In step S706, if the print processing unit 104b confirms a print document in the print data (YES in step S706), the processing proceeds to step S707. If a print document is not confirmed (NO in step S706), the processing returns to step S702, and the processes of step S702 and the subsequent steps are repeated.

In step S707, the print processing unit 104b performs the printing process on the print document according to the print settings set in steps S703 and S705.

A printer-specific print setting is a print control command that has been used by a conventional printer driver. The print control command that has been used by the conventional printer driver is made available between (a print setting extension app of) a client and a printer, using an IPP extension attribute. Consequently, it is possible to efficiently extend a function for using a print function of a printer that is not defined by the IPP.

Although printing using a cloud print service has been described above, the present disclosure may be applied to printing using a local printer driver. In this case, the processing of the cloud print service 121 is performed by the printer 104, or processing is performed between the client terminal 101 and the printer 104 not via the cloud print service 121.

Other functions may also be included in the extension attributes. For example, the following functions illustrated in FIGS. 8 and 10 can be included in the extension attributes.

Double punching is a function of punching holes on two pages imposed in a 2-in-1 manner, for example, on the assumption that an A3 sheet is cut into an A4 size.

In IPP attribute finishings, punching positions on the sheet on which one page is imposed can be specified (punch-left and punch-right), but punching positions on the sheet on which two pages are imposed in a 2-in-1 manner cannot be specified. Accordingly, printer-specific print attributes regarding double punching (attribute values val_double_left, right, and middle of pid_finishing_punch) are included in the IPP extension attributes, whereby the client terminal 101 can use the printer-specific print attributes.

In the case of the examples of the printer print attributes in FIGS. 8A and 8B (801), the punching of holes on the left sides of both left and right pages imposed on the A3 sheet is val_double_left, and the punching of holes on the right sides of both pages is val_double_right.

Then, the punching of holes on the right side of the left page and the left side of the right page (as a result, two places in the center of the A3 sheet) is val_double_middle.

At this time, in the case of the printer capability information in FIGS. 8A and 8B (802), it is indicated that the printer 104 does not support the double punching function. If, on the other hand, the printer 104 supports the double punching function, the printer 104 has information regarding the attribute values (val_double_left, right, and middle) of the double punching supported by the printer 104.

FIGS. 10A and 8B illustrate, in the binary attribute values 1001 and 1002, examples of the printer print attribute pid_finishing_punch included in the extension attributes in a request for capability information and a response of capability information.

Color adjustment (pid_color_adjust), brightness (pid_color_blightness), and contrast (pid_color_contrast) are functions capable of finely adjusting the color, the brightness, and the contrast when printing is performed. All these functions are functions that cannot be specified in the IPP attributes, and therefore, printer-specific print attributes regarding the functions are included in the IPP extension attributes, whereby the client terminal 101 can use the functions.

In the case of the examples of the printer print attributes in FIGS. 8A and 8B (801), the color adjustment (pid_color_adjust) can make adjustments to cause the colors of cyan, magenta, and yellow to come out stronger when printing is performed.

In the case of the printer capability information in FIGS. 8A and 8B (802), the printer 104 supports the color adjustment function and can set levels from 0 to 10 for the strength of the color adjustment function.

The brightness (pid_color_blightness) can adjust the brightness of the color when printing is performed. In the case of the printer capability information in FIGS. 8A and 8B (802), the printer 104 can set levels from 0% (dark) to 100% (bright) for the brightness of the color.

The contrast (pid_color_contrast) can adjust the contrast of the color when printing is performed. In the case of the printer capability information in FIGS. 8A and 8B (802), it is indicated that the printer 104 supports the contrast function and can set levels from 0% (weak) to 100% (strong) for the contrast of the color.

FIGS. 10A and 10B illustrate, in the binary attribute values 1001 and 1002, examples of the printer print attributes pid_color_adjust, pid_color_blightness, and pid_color_contrast included in the extension attributes in a request for capability information and a response of capability information.

Print start position (pid_print_start_position) is a function of adjusting the print position if printing on a sheet is different from an expected result. This function is a function that cannot be specified in the IPP attributes, and therefore, a printer-specific print attribute regarding the function is included in the IPP extension attributes, whereby the client terminal 101 can use the function.

In the case of the examples of the printer print attributes in FIGS. 8A and 8B (801), the print start position (pid_print_start_position) can be specified for both the front surface and the back surface of a sheet. In the case of the printer capability information in FIGS. 8A and 8B (802), it is indicated that the printer 104 can adjust a print start position on the front surface and the back surface of a sheet in the range of -5.0 to +5.0 mm in an X-direction and a Y-direction with the origin at the upper left of the sheet. FIGS. 10A and 10B illustrate, in the binary attribute values 1001 and 1002, examples of the printer print attribute pid_print_start_position included in the extension attributes in a request for capability information and a response of capability information.

Gamma correction (pid_gammma_level) is a function of adjusting brightness so that the brightest portion or the darkest portion of print data is not impaired. This function is a function that cannot be specified in the IPP attributes, and therefore, a printer-specific print attribute regarding the function is included in the IPP extension attributes, whereby the client terminal 101 can use the function.

In the case of the examples of the printer print attributes in FIGS. 8A and 8B (801), the gamma correction (pid_gammma_level) can be specified for a character, graphics, and an image included in print data. In the case of the printer capability information in FIGS. 8A and 8B (802), the printer 104 supports the gamma correction (pid_gammma_level) function and can specify four levels from 0 to 3 for each of a character, graphics, and an image in print data.

Blank sheet saving (pid_skip_blank_page) is a function of, if print data includes a blank sheet, not printing this blank sheet page to save the sheet. This function is a function that cannot be specified in the IPP attributes, and therefore, a printer-specific print attribute regarding the function is included in the IPP extension attributes, whereby the client terminal 101 can use the function.

In the case of the examples of the printer print attributes in FIGS. 8A and 8B (801), the blank sheet saving (pid_skip_blank_page) can specify "OFF" and "ON". In the case of the printer capability information in FIGS. 8A and 8B (802), it is indicated that the printer 104 supports the blank sheet saving function.

FIGS. 10A and 10B illustrate, in the binary attribute values 1001 and 1002, examples of the printer print attribute pid_skip_blank_page included in the extension attributes in a request for capability information and a response of capability information.

Barcode mode (pid_barcode_mode) is a print mode dedicated to a barcode and is a function of making a printed barcode more likely to be recognized by a barcode reader. This function is a function that cannot be specified in the IPP attributes, and therefore, a printer-specific print attribute regarding the function is included in the IPP extension attributes, whereby the client terminal 101 can use the function.

In the case of the examples of the printer print attributes in FIGS. 8A and 8B (801), the barcode mode (pid_barcord_mode) can specify "OFF" and "ON". In the case of the printer capability information in FIGS. 8A and 8B (802), it is indicated that the printer 104 supports the barcode mode function. FIGS. 10A and 10B illustrate, in the binary attribute values 1001 and 1002, examples of the printer print attribute pid_barcord_mode included in the extension attributes in a request for capability information and a response of capability information.

Special mode (pid_special_mode) is a function of, in a case where a phenomenon where toner spatters on the periphery of a character depending on the type of a sheet on which printing is performed becomes conspicuous, preventing the phenomenon by changing a print process of a printer engine. This function is a function that cannot be specified in the IPP attributes, and therefore, a printer-specific print attribute regarding the function is included in the IPP extension attributes, whereby the client terminal 101 can use the function.

In the case of the examples of the printer print attributes in FIGS. 8A and 8B (801), the special mode (pid_special_mode) can specify "OFF" and "ON". In the case of the printer capability information in FIGS. 8A and 8B (802), it is indicated that the printer 104 supports the special mode function. FIGS. 10A and 10B illustrate, in the binary attribute values 1001 and 1002, examples of the printer print attribute pid_special_mode included in the extension attributes in a request for capability information and a response of capability information.

Measures to adjust whitegap (pid_whitegap_adjust) is a function of remedying the occurrence of "whitegap" where, when there is a dark color of the same color immediately after halftone, the halftone side near the boundary of the dark color becomes white like a thin line. This function is a function that cannot be specified in the IPP attributes, and therefore, a printer-specific print attribute regarding the function is included in the IPP extension attributes, whereby the client terminal 101 can use the function.

In the case of the examples of the printer print attributes in FIGS. 8A and 8B (801), the measures to adjust whitegap (pid_whitegap_adjust) can specify "OFF" and "ON". In the case of the printer capability information in FIGS. 8A and 8B (802), it is indicated that the printer 104 supports the measures-to-adjust-whitegap function. FIGS. 10A and 10B A and 10B illustrate, in the binary attribute values 1001 and 1002, examples of the printer print attribute pid_special_mode included in the extension attributes in a request for capability information and a response of capability information.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-011381, filed January 27, 2025, which is hereby incorporated by reference herein in its entirety.

What is claimed is:

1. A non-transitory computer-readable storage medium storing an application program which causes an information processing apparatus to perform a control method, the application program cooperating with Internet Printing Protocol (IPP) Class Driver, the control method comprising:
specifying predetermined attribute information to request capability information indicating functions available on a printing apparatus;
receiving, in response to the request, capability information including information regarding a plurality of different setting items; and
causing a display of the information processing apparatus to display the setting items.

2. The non-transitory computer-readable storage medium according to claim 1, wherein the control method further comprises:
classifying setting values of the plurality of setting items selected by a user into predefined groups; and
outputting the classified setting values to the printing apparatus selected as a print destination of print data.

3. The non-transitory computer-readable storage medium according to claim 2, wherein the groups are a JOB group, a BIND group, and a DOC group.

4. The non-transitory computer-readable storage medium according to claim 2,
wherein print data reflecting the selected setting values is generated by executing the application program, and
wherein the generated print data is output to the printing apparatus via an operating system of the information processing apparatus.

5. The non-transitory computer-readable storage medium according to claim 1, wherein the plurality of setting items includes at least one of smoothing, punching, color adjustment, brightness, contrast, print start position, gamma correction, blank sheet saving, and barcode mode functions.

6. The non-transitory computer-readable storage medium according to claim 1, wherein the plurality of setting items is displayed on a print settings screen provided by the application program.

7. The non-transitory computer-readable storage medium according to claim 1, wherein the IPP Class Driver cannot display the plurality of setting items.

8. A control method of an information processing apparatus in which an IPP Class Driver and an application program cooperating with the IPP Class Driver are installed, the control method comprising:
specifying predetermined attribute information to request capability information indicating functions available on a printing apparatus;
receiving, in response to the request, capability information including a plurality of setting items; and
causing a display of the information processing apparatus to display the setting items.

9. An information processing apparatus comprising:
at least at least one processor; and
a memory storing an IPP Class Driver and an application program configured to cooperate with the IPP Class Driver, wherein the at least one processor is configured to:
specify predetermined attribute information to request capability information indicating functions available on a printing apparatus;
receive, in response to the request, capability information including a plurality of setting items; and
causing a display of the information processing apparatus to display the setting items.
